(19) United States
(12) Patent Application Publication
(10) Pub. No.: US 2006/0026058 A1
(43) Pub. Date: Feb. 2, 2006

(54) System and method for accessing remote information

(76) Inventor: Martin Allan White, Saint Louis, MO (US)

Correspondence Address: Martin White, 5003 Bancroft Ave, Saint Louis, MO, 63109, US

(21) Appl. No.: 10/900,263

(22) Filed: Jul. 27, 2004

(51) Int. Cl. G06F 17/60

(52) U.S. Cl. 705/12

(57) ABSTRACT

A system and a method for facilitating an election. A database containing voter registration information is downloaded from a central computer to a portable computer that is accessible at a polling station. The database can be searched by a proctor or official at the polling station to determine whether a prospective voter is eligible to vote at the polling station. The name or name and date of birth of the prospective voter is entered into a search field of the portable computer and the database is searched. If and when a matching record is found, additional information is displayed on a second screen and the proctor or official can make a determination whether the prospective voter is eligible to vote at the polling place.

### BACKGROUND OF THE INVENTION

1. Field of the Invention

The invention relates to a system and method of delivering and accessing electronic information at a point of service. Specifically, a system and method of delivering and accessing voter role information in an electronic format at a polling station is provided.

2. Description of the Related Art

To ensure the health of a free and democratic society, it is essential that voting be carried out in a fair and efficient manner, and in compliance with state and federal statutes. Individuals who are not registered voters, who have been placed on the inactive voters list, and who no longer reside in the ward or district of a particular polling station must be identified and not permitted to vote at that polling station. Conversely, those individuals permitted under the rules to vote at a particular polling station must be properly identified and counted as having voted.

Presently, individual polling stations have an updated paper copy of the inactive voters. These lists can be greater than a thousand pages for any given large municipality, which can have several hundred individual polling stations. This system is very inefficient and prone to inaccuracies. For example, when a prospective voter enters a polling station, his or her name is checked against the list of registered voters for that particular polling station. If the prospective voter is not on the list, the inactive voter list is consulted to determine whether the prospective voter is active. If the prospective voter is indeed still active, the polling station monitor will contact the election office, which will obtain the name and date of birth date of the prospective voter and determine the appropriate polling station for the prospective voter.

This system is inefficient, expensive and prone to error. For example, in some districts, polling stations are furnished with expensive cell phones for use in contacting the election office to obtain voter information, since each polling station does not have direct access to the entire voting roles.

### SUMMARY OF THE INVENTION

An object of the invention is a system and method of directly accessing up-to-date and useful information on a portable electronic device (e.g., computer).

In a preferred embodiment, the up-to-date and useful information is voter information. The method comprises the steps of downloading data from a central database onto a portable computer located at a polling station, entering a first information into a searchable field displayed on the portable computer, and obtaining additional information associated with the first information, and making a decision regarding the person associated with the name. In a preferred embodiment, the portable computer is located at a polling, the first information is a name, and the additional information comprises the status of a prospective voter as inactive or not. Preferably, the method additionally comprises compiling an up-to-date and useful information database, which, for example but not exclusively, may be a voter registration database that includes name, date-of-birth, address, ward and precinct (or the equivalent thereof) for each voter in a state or municipality. The decision to allow or to disallow a prospective voter to vote at the polling station is based upon information displayed on the second screen.

Another object of the invention is an electronic information system, which comprises a central database that contains voter information, a central computer that houses the central database, a portable computer, a means for transferring data between the central computer and the portable computer, a software program that enables a user to enter first information into a field and retrieve additional useful information related to the first information. While the database may relate to any and all myriad useful information, in a preferred embodiment, the database is directed to voter registration information, which comprises name, date-of-birth, address, precinct and ward (or equivalent thereof), and status (e.g., active or inactive) for a prospective voter. Alternatively, but not to the exclusion of the previous, the database may comprise a list of inactive voters.

### BRIEF DESCRIPTION OF THE DRAWINGS

FIG. 1 depicts an electronic voter registration system.

FIG. 2 depicts a method of conducting an election.

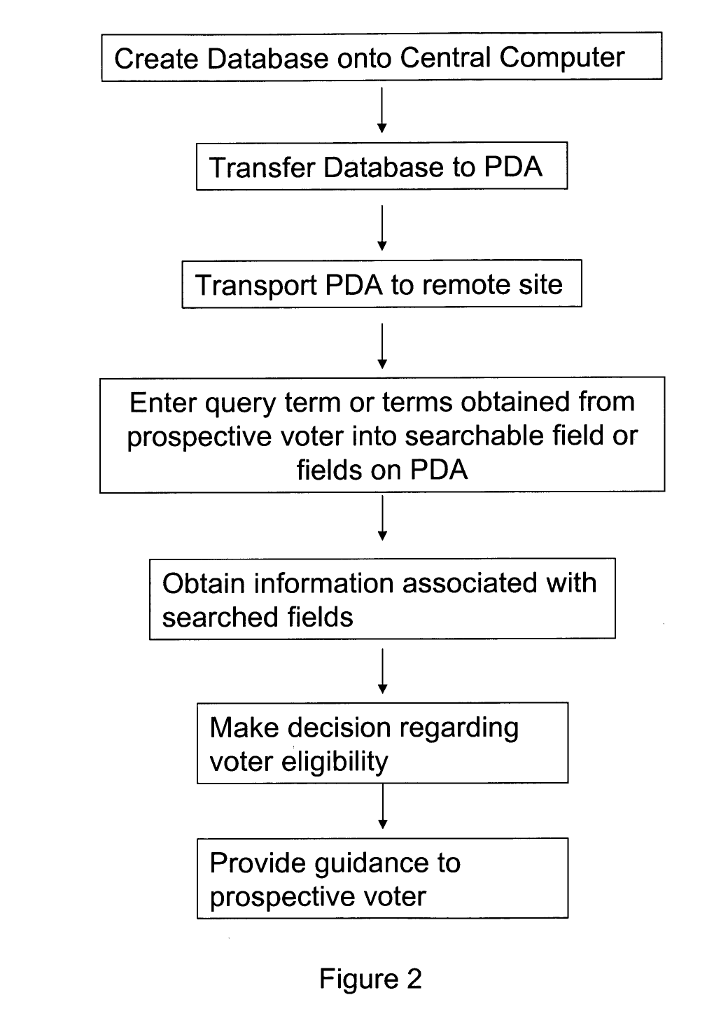

FIG. 3 depicts an exemplary PDA screen shot showing a query field.

FIG. 4 depicts an exemplary PDA screen shot showing an active voter.

FIG. 5 depicts an exemplary PDA screen shot showing an inactive voter.

FIG. 6 depicts an exemplary PDA screen showing an ineligible voter.

### DETAILED DESCRIPTION OF THE PREFERRED EMBODIMENTS

The inventor has developed a system and method for enabling the access of information contained in a large database on a portable computer useable at a remote site. The inventor envisions that the system is applicable to any business method wherein useful information housed on a central computer may be downloaded onto a portable computer for use at a site distant from the central computer. Thus, the invention is not to be construed to be limited solely to the embodiment herein disclosed, but by the claims which follow.

The inventor has recognized the need for reliable and readily accessible information at polling stations. Currently, voter registration information is printed, bound and distributed by an election office to individual polling stations. The information is then used by a polling station proctor or official to determine if a prospective voter, who enters a polling station, is eligible to vote. Inactive voter lists are consulted and if the prospective voter's name appears on the list, the prospective voter is not allowed to vote. However, if the prospective voter is not on the roster for a particular polling station and is not on the inactive voter list, the polling station official can contact the election office to determine which polling station the prospective voter should report to to vote. Thus, the inventor has invented a system and a method for efficiently delivering accurate and up-to-date voter registration information to each polling station in a voting area.

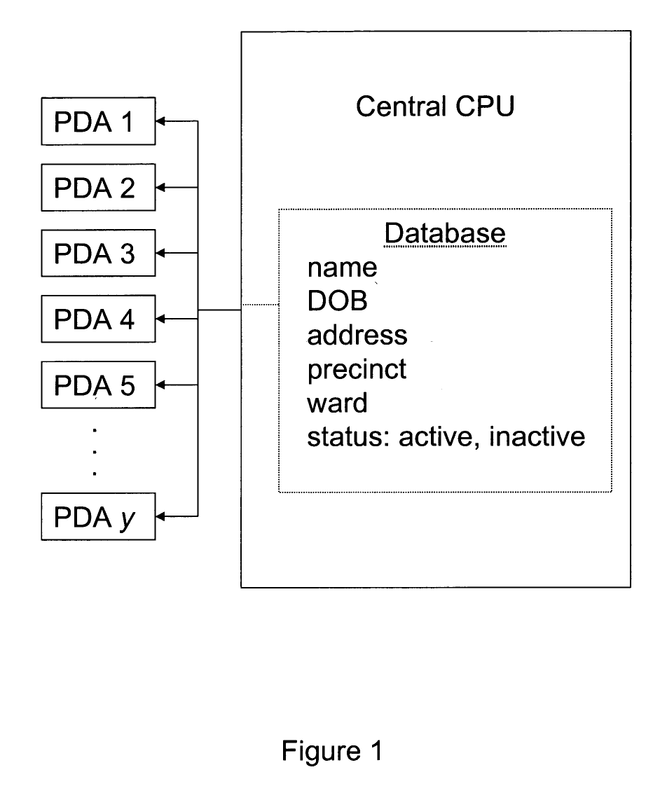

In one embodiment, the invention is directed to an electronic voter registration system. In a particular preferred embodiment (FIG. 1), the electronic voter registration system comprises a database of voter information in electronic format. The database contains records for registered voters of a particular voting area (municipality, state, and the like), wherein each record includes the name, date of birth and address of a voter. More preferably, each record also includes the precinct, ward and status of the voter. Status refers to whether the voter is active or inactive. Alternatively, but not exclusively, status can refer to whether a voter has already cast a ballot in the current election, and is therefore ineligible to vote again. Database structures are well known in the computer arts and are readily available as shareware, freeware and from commercial vendors such as FileMaker, Gupta, iAnywhere, InterSystems, IBM, Microsoft, Oracle, Pervasive Software, Progress Software, Sybase, and TimesTen.

Preferably, the database, which is maintained and up-to-date, resides on a central computer, which may be a server, personal computer, or the like, and which may be located in an election office, space controlled by an election office, or with a vendor, or any combination thereof. Prior to an election, all or part of the database is transferred to one or more portable computers, which are located and used at one or more polling stations. Portable computers include, but are not limited to pocket PC (windows, linux, mac os), cell phone, tablet PC, Palm os device, and laptop computer. In a preferred embodiment, the portable computer is a personal digital assistant (“PDA”). More preferably, the portable computer is a Palm os device, such as, for example, a Palm Zire™ PDA.

The database is transferred from the central computer to the portable computer by any one or more methods that are well known in the art, including, but not limited to, wire transfer means, such as through a USB connection, serial connection, modem or network (i.e., hot synchronization), or wireless means, such as by infrared (“IR”), microwave and radiowave. Examples of wireless transmission methods or protocols include Bluetooth (2.56 GHz band), IrDA (infrared frequencies), and Home RF or SWAP (2.45 GHz range). In a preferred embodiment, the transfer is by hot synchronization of the central computer and a PDA.

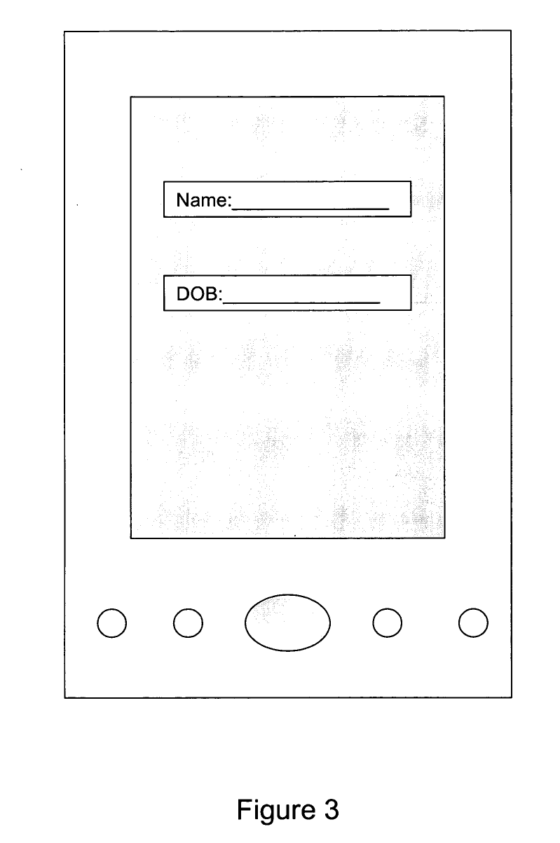

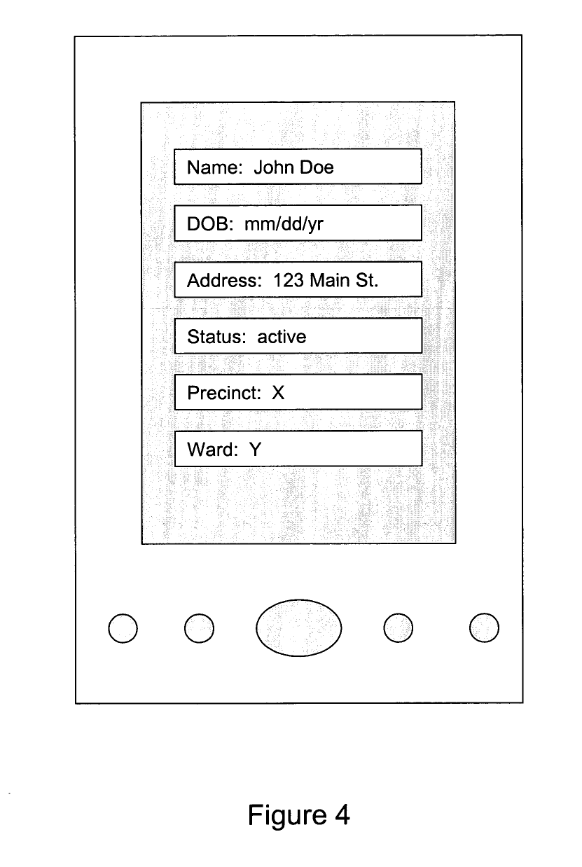

In one embodiment of the system, multiple portable computers contain the database and are distributed to multiple polling stations throughout an official voting area. Displayed on the screen of the portable computer (“first screen”) is a searchable field, into which a polling station official or other individual can input the name of a prospective voter (FIG. 3). The input can be by way of any input device, such as for example a stylus, a keyboard, an optical electronic card, a mouse, and a microphone. Preferably, the name is input using a keyboard or a stylus. The input name is compared to the records of the database and a matching record is called up and useful fields are displayed on the screen of the portable computer (“second screen”) (FIGS. 4, 5 and 6). The polling official or other individual can make a decision to allow or disallow the prospective voter associated with the input name to vote. More preferably, the first screen can display an additional searchable field, such as date-of-birth, to assist in narrowing the database search.

In another embodiment, the invention is directed to a method of facilitating an election. The method enables an official or proctor at a polling station to access information about a prospective voter on an easy to use portable computer, and to provide useful advice to the prospective voter. The method comprises creating, importing or updating a database, which contains voter records, on a central computer. The database is downloaded onto one of more portable computers using a wire, wireless or direct transfer method, wherein the database is stored on a medium that can be moved from the central computer and loaded onto the portable computer (e.g., disc, CD, chip). The central computer can be a server or personal computer that operates using any operating system, such as Palm, Windows, Linux, Mac and the like. Likewise, the portable computer may utilize any operating system, such as Palm, Windows, Linux, Mac and the like. In a preferred embodiment, the central computer utilizes a windows operating system and the portable computer is a personal digital assistant (“PDA”) which utilizes a Palm operating system, and the database is transferred using a hot synchronization method through a USB, serial, modem or network connection.

Having the database loaded onto the portable computer, the portable computer is accessed at a polling station. A prospective voter enters a polling station and presents a proctor or official with a form of identification. The proctor or official enters the name or name and date of birth of the prospective voter into a searchable field displayed on the screen (“first screen”) of the portable computer, which then executes a search program to search the records of the database. If the name or name and date of birth is matched to a record of the database, additional fields associated with that record are displayed on the screen (“second screen”) of the portable computer. Those additional fields include one or more of address, precinct, ward and status of the prospective voter. Status may be active, inactive, ineligible, or not available. Preferably status is either active or inactive. If the name or name and date of birth of the prospective voter does not match with any record in the database, additional fields may not be displayed on the second screen, but rather a notification is displayed on the second screen indicating that no match was found in the database.

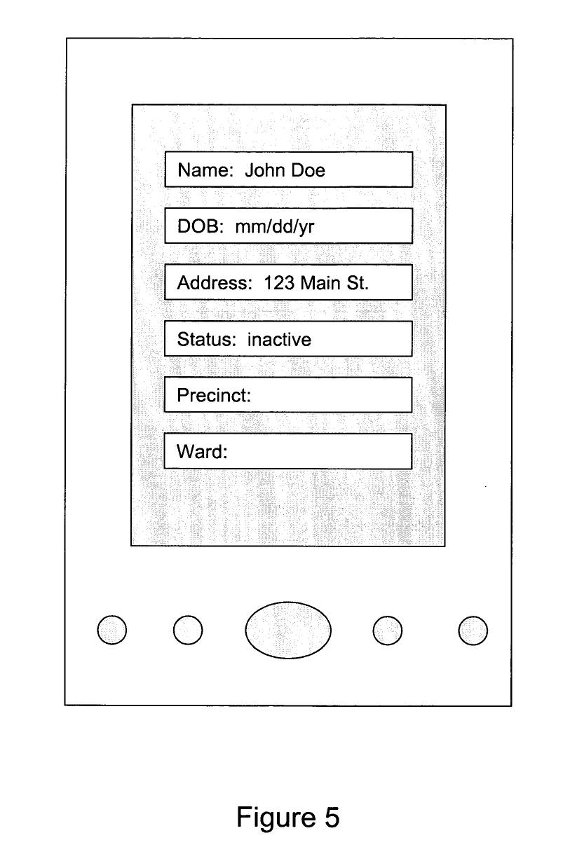

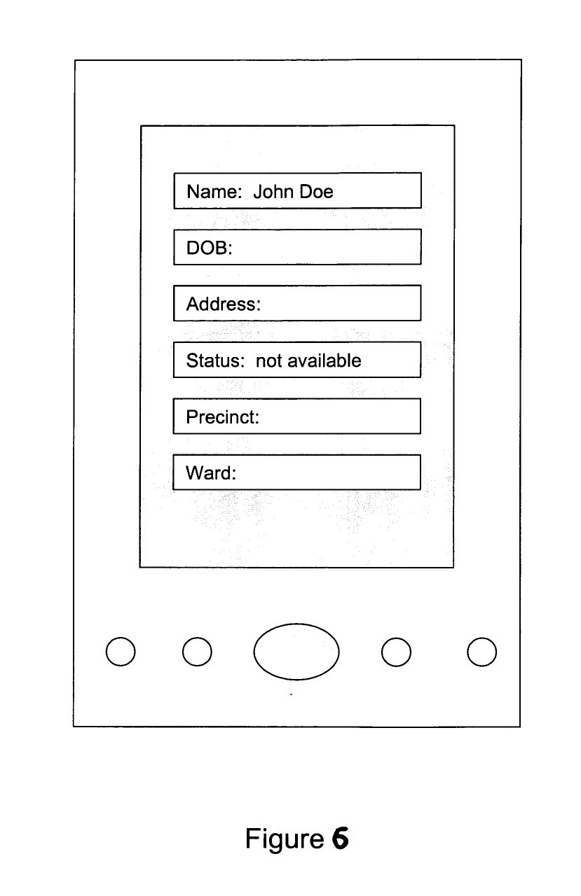

Having obtained additional information related to the prospective voter, the proctor or official at the polling station makes a decision whether to allow or disallow the prospective voter to vote at the polling place. If the prospective voter has a status of active and the precinct and ward match with the polling place, the voter may be allowed to proceed to vote (FIG. 4). If the prospective voter has a status of inactive, the voter may not be allowed to proceed to vote (FIG. 5). If the prospective voter has a status of active and the precinct and ward do not match with the polling place, the proctor or official may notify the prospective voter of the proper polling place that serves the precinct and ward of the voter. If no record match has been found related to the name or name and date of birth, the voter may not be allowed to proceed to vote (FIG. 6).

In yet another embodiment, the invention is directed to an electronic voter system as described above, wherein the database comprises the records of inactive voters. The database resides on a central computer and is downloadable to a portable computer.

In yet another embodiment, the invention is directed to a method of facilitating an election, comprising updating a database comprising an inactive voter list, downloading the database to one or more portable computers, entering the name or name and date of birth into a searchable field on the first screen of the portable computer, whereby the name or name and date of birth are searched against the database. If and when the name or name and date of birth are associated with a record in the database which comprises the inactive voter list, a record is displayed on the second screen of the portable computer, indicating that the prospective voter is inactive and therefore not allowed to vote.

Preferred embodiments of the invention are described above. Other embodiments within the scope of the claims herein will be apparent to one skilled in the art from consideration of the specification or practice of the invention as disclosed herein. It is intended that the specification be considered exemplary only, with the scope and spirit of the invention being indicated by the claims which follow below.

What is claimed is:

1. An electronic voter registration system comprising a central computer, a voter information database, and multiple portable computers, wherein the voter information database (a) resides in the central computer, (b) is capable of being transferred to one or more of the multiple portable computers, and (c) comprises names and addresses of active and inactive voters in a voting area.

2. The electronic voter registration system of claim 1 wherein the central computer is located in an election office.

3. The electronic voter system of claim 1 wherein the central computer is controlled by a vendor.

4. The electronic voter registration system of claim 1 wherein the voter information database comprises the name, address, date of birth, precinct, ward and status for a voter.

5. The electronic voter registration system of claim 4 wherein the status comprises one or more of active, inactive, voted, and not voted.

6. The electronic voter registration system of claim 1 wherein the voter information database is transferred to a portable computer.

7. The electronic voter registration system of claim 6 wherein the portable computer comprises the voter information database.

8. The electronic voter registration system of claim 7 wherein the portable computer is located at a polling station.

9. The electronic voter registration system of claim 8 wherein the portable computer is a Palm OS based personal digital assistant and the voter information database is searchable by name, address or both.

10. An electronic voter registration system comprising (a) a central computer, (b) a voter information database, which comprises a record for each active and inactive voter in a voting area, wherein the record comprises name, address, date of birth, precinct, ward, and voting status, and (c) a personal digital assistant; wherein,
(i) the voter information database is transferable from the central computer to the personal digital assistant,
(ii) the personal digital assistant, on which the voter information database or a subset thereof is loaded, is portable to a polling station, and
(iii) the voter information database or the subset thereof can be queried by input of a name and date of birth into a searchable field displayed on a first screen of the personal digital assistant, wherein the voting status, precinct, ward and address associated with the name and date of birth are displayed on a second screen of the personal digital assistant.

11. A method of facilitating a voting process comprising (a) downloading a database onto a portable computer, (b) entering first information obtained from a prospective voter into a searchable field on the portable computer at a polling station, (c) obtaining additional second information related to the first information, (d) making a decision based upon the second information whether to allow the prospective voter to vote at the polling station.

12. The method of claim 11 wherein the database is downloaded from a central computer to the portable computer via a wireless or a wire-mediated process.

13. The method of claim 12 wherein the central computer is located in an election office and the portable computer is located at a polling station.

14. The method of claim 13 wherein the entering first information is made using an input device selected from the group consisting of keyboard, microphone, optical code scanner, and stylus.

15. The method of claim 14 wherein the input device is a keyboard.

16. The method of claim 13 wherein the additional second information comprises address, precinct, ward, and status, wherein status is directed to active or inactive.

17. The method of claim 16 wherein the status indicates that the prospective voter is inactive, whereby the decision is to not allow the prospective voter to vote.

18. The method of claim 16 wherein no additional second information is obtained, whereby the decision is to not allow the prospective voter to vote.

19. The method of claim 16 wherein the additional second information indicates that the status is active, and the ward is not served by the polling station, whereby the decision is to not allow the prospective voter to vote at the polling station.

20. The method of claim 16 wherein the additional second information indicates that the status is active and the ward is served by the polling station, whereby the decision is to allow the prospective voter to vote.

21. A method to facilitate voting comprising the steps of (a) downloading from a central computer a database onto a personal digital assistant via a hot synchronization method, wherein the database contains multiple records of voter information comprising the fields of name, address, date of birth, voting status, precinct and ward, (b) transporting the personal digital assistant to a polling station, (c) obtaining a name and a date of birth from a perspective voter, (d) entering the name and the date of birth obtained from the prospective voter into a searchable field on the personal digital assistant, (e) searching the database, (f) obtaining from database the address, the voting status, the precinct and the ward associated with the name and the date of birth obtained from the prospective voter, and (g) making a decision whether to allow the prospective voter to vote at the polling station, wherein
(i) if the status is inactive, the decision is to not allow the prospective voter to vote at the polling station,
(ii) if the status is active and the ward is served by the polling station, the decision is to allow the prospective voter to vote at the polling station,
(iii) if the ward is not served by the polling station, the decision is to not allow the prospective voter to vote at the polling station, and
(iv) if the prospective voter is not found in the database, the decision is to not allow the prospective voter to vote at the polling station.
